(19) United States
(12) Patent Application Publication
(10) Pub. No.: US 2024/0241943 A1
(43) Pub. Date: Jul. 18, 2024

(54) NESTED ISOLATION HOST VIRTUAL MACHINE

(71) Applicant: Microsoft Technology Licensing, LLC, Redmond, WA (US)

(72) Inventors: Bruce John SHERWIN, Jr., Woodinville, WA (US); Alexander Daniel GREST, Redmond, WA (US); Xin David ZHANG, Redmond, WA (US); David Alan HEPKIN, Redmond, WA (US); Aditya BHANDARI, Seattle, WA (US)

(21) Appl. No.: 18/576,056

(22) PCT Filed: Jul. 13, 2022
(86) PCT No.: PCT/US2022/073684

§ 371 Date: Jan. 2, 2024

(30) Foreign Application Priority Data
Jul. 19, 2021 (LU) LU500447

(51) Int. Cl. G06F 21/53; G06F 21/54; G06F 21/60

(52) U.S. Cl. CPC G06F 21/53; G06F 21/54; G06F 21/602

(57) ABSTRACT

A computer system supports a nested isolation host. The computer system operates a hypervisor that creates a virtualized interface to a security module that is configured to provide hardware-based virtual machine isolation functionality, and that creates a child partition that comprises a nested hypervisor. The hypervisor presents the virtualized interface to the child partition. Based on receiving a command at the virtualized interface from the nested hypervisor, the hypervisor performs one of (i) modifying the command and forwarding a modified command to the security module, (ii) forwarding the command to the security module, or (iii) blocking the command.

### TECHNICAL FIELD

The present disclosure relates to systems, methods, and devices that create hardware-isolated virtual machines leveraging a hardware security module.

### BACKGROUND

Hypervisor-based virtualization technologies isolate portions of a computer system's physical resources (e.g., processor cores and/or time, physical memory locations, storage resources, etc.) into separate child partitions, and execute guest software within each of those partitions in isolation from software executing in other partitions. Hypervisor-based virtualization technologies therefore facilitate creation of virtual machines (VMs) that each executes different a different guest operating system, different guest processes, etc. in isolation from software executing outside of that VM.

Some computer systems include one or more hardware security modules designed to further isolate VMs from even the hypervisor, by enabling per-VM hardware-based memory encryption, processor state encryption, and memory integrity protection (e.g., page table protection). For example, contemporary processors from ADVANCED MICRO DEVICES (AMD) of Santa Clara, California support technologies known as AMD Secure Technology. These technologies rely on a Platform Security Processor (PSP) that is responsible for creating, monitoring, and maintaining a security environment. One comparable technology, from INTEL CORPORATION of Santa Clara, California, is the Trust Domain Extensions (TDX) module that executes on a processor in a Secure-Arbitration Mode (SEAM). Another comparable technology, from ARM Ltd. of Cambridge, England, is the ARM Confidential Compute Architecture.

With reference to AMD Secure Technology, and the PSP, Secure Encrypted Virtualization (SEV) is a technology designed to isolate VMs from the hypervisor. With SEV, individual VMs are assigned a unique encryption key that is used to automatically encrypt their in-use data; then, when a component such as the hypervisor attempts to read memory inside a guest, it is only able to see the encrypted bytes. Encrypted State (SEV-ES) adds additional protection for processor register state. In SEV-ES, the VM register state is encrypted on each hypervisor transition so that the hypervisor cannot see the data actively being used by the VM. Together with SEV, SEV-ES can reduce the attack surface of a VM by helping protect the confidentiality of data in memory. Secure Nested Paging (SEV-SNP) adds memory integrity protection to help prevent malicious hypervisor-based attacks like data replay, memory re-mapping, etc. to create an isolated execution environment

### BRIEF SUMMARY

Existing hardware security mechanisms, such as AMD PSP, INTEL TDX, and the ARM Confidential Compute Architecture, enable “L1” VMs that are created by an “L0” hypervisor (i.e., a hypervisor that executes directly on host computing system hardware) to either be fully protected by a given hardware security mechanism, or lack that protection. For example, an L1 VM either has all its memory encrypted by SEV, or SEV is inactive; an L1 VM either has its processor register state protected by SEV-ES, or SEV-ES is inactive; or an L1 VM either has memory integrity protection active using SEV-SNP, or SEV-SNP is inactive. This can lead to an inflexibility and inefficiency when managing VMs, particularly in environments in which a hosting provider provides VM hosting services to multiple tenants.

For example, a tenant may operate modular guest software, in which it may be beneficial to execute one or more first components of the guest software under hardware-enforced isolation (e.g., in one or more first VMs protected by SEV, SEV-ES, SEV-SNP, etc.) and to execute one or more second components of the guest software under normal hypervisor-based isolation (e.g., in one or more second VMs not protected by SEV, SEV-ES, SEV-SNP, etc.). Using current technology, the hosting provider makes computing resource allocations (processor, memory, etc.) for a plurality of L1 VMs, some of which utilize hardware-enforced isolation, and these L1 VMs are used to host the various guest software components. Since the hosting provider may lack knowledge of the guest software, the hosting provider may make less-optimal resource allocations than the tenant (having knowledge of the guest software) may have made-which may waste computing resources. Further, the tenant may need to involve the hosting provider to re-configure the VM allocations as needs change. Additionally, since multiple VMs operate different components of modular guest software, it may be necessary to treat these multiple VMs like a single entity from a fabric perspective (e.g., these plural VMs need to be migrated, shuts down, started, etc. as a group). This can lead to scheduling and administrative complexity, since those L1 VMs are not inherently linked.

At least some embodiments described herein enable a new type of L1 VM, referred to herein as a nested isolation host (NIH), which comprises an L1 nested hypervisor capable of interacting with a hardware security module (e.g., a PSP) to create one or more hardware isolated L2 VMs, potentially along with one or more conventional L2 VMs. In particular, the L0 hypervisor virtualizes access to the hardware security module (e.g., a virtual PSP), which enables the nested hypervisor in the NIH to request hardware isolation features for VMs created by the nested hypervisor. In embodiments, the virtualized hardware security module modifies and/or filters commands received from the nested hypervisor to ensure those commands are properly used and/or to prevent an NIH from accessing certain hardware security module features.

In embodiments, the function of the NIH VM-including function of the nested hypervisor—is under tenant control. Thus, the NIH VM enables a tenant to create L2 VMs that utilize hardware isolation features, rather than relying on the hosting provider to create those VMs as L1 VMs. Thus, an NIH VM enables a tenant-rather than a hosting provider—to granularly control of resource allocations to VMs that are used to operate modular guest software. This means that host computer system resources can be more efficiently allocated within a single L1 VM to meet the needs of the guest software that utilizes a mix of convention VMs and hardware isolated VMs than was possible prior to the invention of the NIH VM. The technical effect of this is a more efficient use of computing resources.

In embodiments, since the NIH VM is an L1 VM, all the L2 VMs that are created within the NIH VM are treated together as a single unit by the L0 hypervisor. This means that the L0 hypervisor automatically manages (e.g., migrates, shuts down, starts, etc.) all the L2 VMs within the NIH VM as a single unit when the NIH VM is itself migrated, shut down, started, etc. The L1 hypervisor within the NIH VM, on the other hand, can simply shut down, start, etc. all the L2 VMs under its control when the NIH VM is shut down, started, etc., without needing to track which L2 VMs should be handled together. As such, the NIH VM enables a mix of hardware-isolated and conventional L2 VMs to be managed as a single unit by the L0 hypervisor, and by the L1 hypervisor, without requiring either the L0 hypervisor or the L1 hypervisor to track which L2 VMs should be managed together. This provides an additional technical effect of simplifying VM-related configuration information and VM-related management tasks.

In embodiments, the L0 hypervisor tracks information received from one or more NIH VMs, and translates that information to ensure proper use of the hardware security module by the NIH VM(s). In an example, some commands supported by the hardware security module may require specification of an address space identifier (ASID) corresponding to a partition. However, each NIH VM only has knowledge of L2 VMs created by that NIH VM, and one NIH VM may therefore use an ASID that conflict with another NIH VM (or even with the L0 hypervisor). As such, in embodiments the L0 hypervisor tracks ASIDs used by all NIH VMs and modifies commands received from NIH VMs to translate ASIDs used by NIH VMs to ASIDs that are valid and expected by the hardware security module. This provides an additional technical effect of resolving conflicts between how different NIH VMs expect to use the hardware security module.

In some embodiments, methods, systems, and computer program products support a nested isolation host. In an embodiment, a computer system comprises a processor, a security module that is configured to provide hardware-based virtual machine isolation functionality, and a hardware storage device that stores computer-executable instructions that are executable by the processor to cause a hypervisor to support a nested isolation host. The hypervisor creates a virtualized interface to the security module and creates a child partition that comprises a nested hypervisor. The hypervisor presents the virtualized interface to the child partition. Based on receiving a command at the virtualized interface from the nested hypervisor, the hypervisor performs one of (i) modifying the command and forwarding a modified command to the security module, (ii) forwarding the command to the security module, or (iii) blocking the command.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates providing a NIH partition/VM;

FIG. 2 illustrates an example of a virtualized security module; and

FIG. 3 illustrates a flow chart of an example method for providing a NIH.

### DETAILED DESCRIPTION

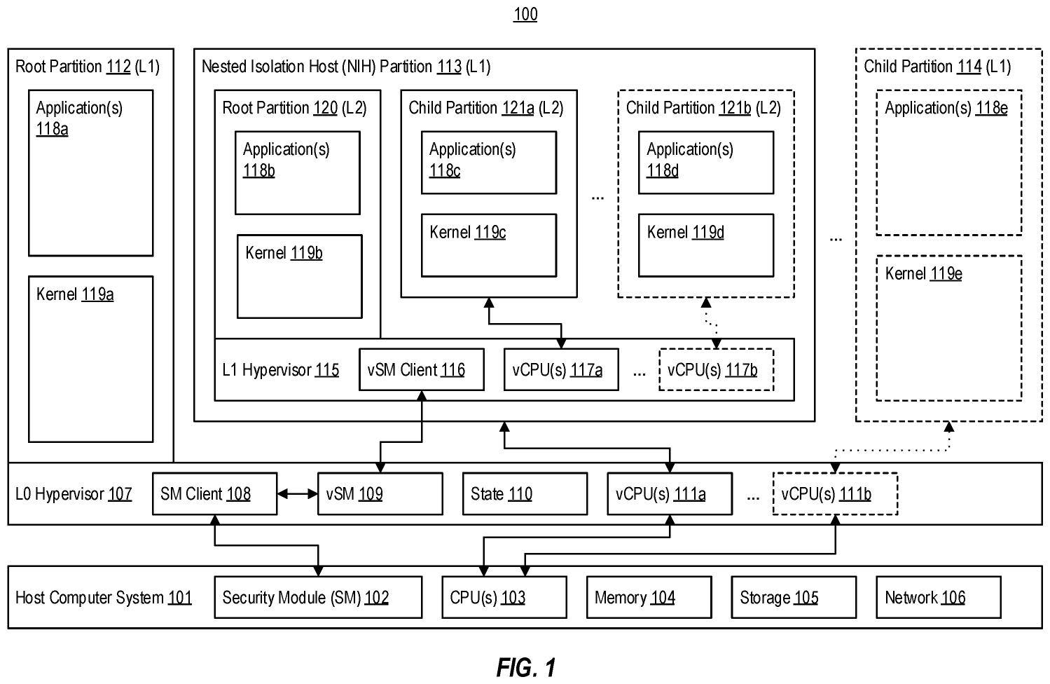

FIG. 1 illustrates an example computer architecture 100 that facilitates providing a NIH partition/VM. As shown, computer architecture 100 comprises a host computer system 101 that comprises at least a security module 102, at least one processor (CPU 103), main or system memory (memory 104), and at least one durable storage device (storage 105). The host computer system 101 can also comprise a variety of other hardware devices, such as at least one network interface device (network 106). In embodiments, host computer system 101 is a special-purpose or general-purpose computer system, as described in more detail infra.

Example computer architecture 100 illustrates a virtualization environment comprising a hypervisor 107. As will be appreciated by one of ordinary skill in the art, the hypervisor 107 is arranged in computer architecture 100 as a “type-1” hypervisor (e.g., the HYPER-V hypervisor from Microsoft Corporation or the open-source XEN hypervisor), in which the hypervisor runs underneath a root partition hosting an operating system kernel. However, it will be appreciated by one of ordinary skill in the art, having read the disclosure herein, that the principles of a nested isolation host (as described herein) can also apply to “type-2” hypervisors (e.g., the LINUX Kernel-based Virtual Machine hypervisor), where the hypervisor is embedded in an operating system kernel. As such, the embodiments herein are not limited to use within example computer architecture 100.

In embodiments, the security module 102 is a hardware-based processor or co-processor that enables the hypervisor 107 to request certain hardware-enforced isolation features for partitions created by the hypervisor 107. In embodiments, the security module 102 implements AMD PSP, INTEL TDX, ARM Confidential Compute Architecture, and the like. In embodiments, the security module 102 provides functionality to encrypt at least a portion of memory allocated to at least one partition created by the hypervisor 107 (e.g., SEV), to encrypt one or more registers corresponding to at least one partition created by the hypervisor 107 (e.g., SEV-ES), to provide memory integrity protection for at least one partition created by the hypervisor 107 (e.g., SEV-SNP), and the like. While the security module 102 is illustrated as being external to the CPU 103, in some embodiments the CPU 103 comprises the security module 102—such as by supporting a mode (e.g., SEAM) which implements, or is used to host, executable instructions (e.g., TDX) that implement the security module 102.

The hypervisor 107 is illustrated as being an L0 hypervisor, meaning that it executes directly (“bare metal”) on the host computer system 101 to create one or more L1 partitions. As shown, in embodiments these L1 partitions include an L1 root partition 112 which interfaces directly with the hypervisor 107 and facilitates management of other L1 child partitions. Additionally, in embodiments these L1 partitions potentially include at least one conventional L1 child partition 114, which operates as a VM supported by at least one virtual CPU (i.e., vCPU 111b). Within each of these L1 partitions/VMs, the host computer system 101 executes guest software-such as one or more applications (i.e., application(s) 118a and application(s) 118e), an operating system kernel (e.g., kernel 119a and kernel 119e), etc.—in relative isolation from other L1 partitions.

The hypervisor 107 is illustrated as comprising a security module client (SM client 108). As indicated by an arrow connecting the security module 102 and the SM client 108, in embodiments the SM client 108 interfaces with the security module 102, enabling the hypervisor 107 to request that the security module 102 provide hardware-based isolation functionality (e.g., SEV, SEV-ES, SEV-SNP, etc.) for one or more L1 partitions created by the hypervisor 107. Thus, for example, in embodiments the SM client 108 enables the hypervisor 107 to request that the security module 102 provide hardware-based isolation functionality for the root partition 112, for child partition 114 (or a plurality of child partitions), etc.

In addition, the hypervisor 107 is illustrated as comprising a virtualized security module (vSM 109) that interfaces with the SM client 108 and, in turn, with the security module 102. In embodiments, the vSM 109 presents a virtualized hardware device that appears to L1 child partitions to be a hardware-based security module (e.g., such as security module 102). In embodiments, the vSM 109 enables the hypervisor 107 to create a new type of L1 partition called a nested isolation host, which is represented in FIG. 1 as NIH partition 113. While, for simplicity, FIG. 1 shows NIH partition 113 singly, in embodiments the hypervisor 107 supports a plurality of NIH partitions.

As shown, like a conventional L1 partition, the NIH partition 113 is also supported by at least one virtual CPU (i.e., vCPU 111a). However, rather than directly hosting client software, the NIH partition 113 hosts a nested L1 hypervisor (nested hypervisor 115) that enables creation of one or more L2 partitions/VMs. As shown, in embodiments these L2 partitions include an L2 root partition 120 which interfaces directly with the nested hypervisor 115 and facilitates management of other L2 child partitions, and one or more L2 child partitions 121 (i.e., child partition 121a, child partition 121b, etc.). Each L2 child partition operates as a VM supported by at least one virtual CPU 117 (i.e., vCPU 117a, vCPU 117b, etc.) created by the nested hypervisor 115. Within each of these L2 child partitions, the host computer system 101 executes client software-such as one or more applications (i.e., application(s) 118b, application(s) 118c, application(s) 118d), an operating system kernel (e.g., kernel 119b, kernel 119c, kernel 119d), etc.—in relative isolation from other L1 and L2 partitions.

As shown, the nested hypervisor 115 comprises a vSM client 116. As indicated by an arrow connecting the vSM 109 and the vSM client 116, in embodiments the vSM client 116 interfaces with the vSM 109, enabling the nested hypervisor 115 to request (via the vSM 109) that the security module 102 provide hardware-based isolation functionality (e.g., SEV, SEV-ES, SEV-SNP, etc.) for one or more L2 partitions created by the nested hypervisor 115. Thus, for example, in embodiments the vSM client 116 enables the nested hypervisor 115 to request that the security module 102 provide hardware-based isolation functionality for one or more of the root partition 120, the child partition 121a, the child partition 121b, etc. Thus, the hardware-based isolation enabled by use of the security module 102 by the SM client 108 is extended to be useable by the NIH partition 113, thus giving the NIH partition 113 be host to “nested” (i.e., L2) hardware-isolated partitions.

Notably, in embodiments, the nested hypervisor 115 uses the vSM client 116 to request hardware-based isolation functionality for less than all L2 child partitions (e.g., to request hardware-based isolation for child partition 121a, but not for child partition 121b). In these embodiments, the NIH partition 113 is usable to spit an application into at least one hardware-isolated portion (e.g., child partition 121a) and at least one non-hardware-isolated portion (e.g., child partition 121b).

In embodiments, the vSM client 116 sends commands, such commands that would be normally formatted for consumption by the security module 102, to the vSM 109. The vSM 109, in turn determines if, and when, to forward those commands to the security module 102 (via the SM client 108). In embodiments, the vSM 109 also forwards any replies received from the security module 102 back to the vSM client 116. In embodiments, the vSM 109 only virtualizes a limited subset of functionality of the security module 102. In embodiments, the vSM 109 filters and/or modifies commands received from the vSM client 116 in order to limit the functionality available to the vSM client 116, and/or in order to ensure proper use of the security module 102 by the vSM client 116, or by a plurality of vSM clients operating at a plurality of NIH partitions.

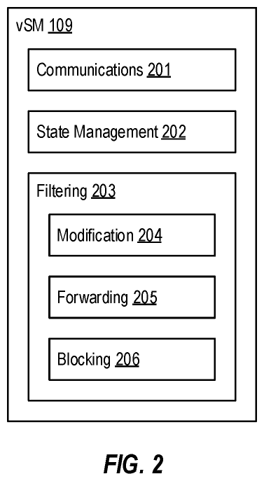

FIG. 2 illustrates details of the vSM 109. As shown, in embodiments the vSM 109 comprises a communications component 201, which receives commands from at least the vSM client 116 operating in nested hypervisor 115 within NIH partition 113. In embodiments, the communications component 201 receives commands from plural vSM's in different NIH partitions. Additionally, the communications component 201 sends commands to the security module 102 (via the SM client 108) and receives replies from the security module 102 (via the SM client 108). The vSM 109 also comprises a state management component 202, which manages state 110 stored at the hypervisor 107.

The vSM 109 also comprises a filtering component 203, which comprises a modification component 204, a forwarding component 205, and a blocking component 206. In general, the modification component 204 modifies a command received from a vSM client 116 prior to forwarding the command to the security module 102 using the forwarding component 205. In general, the forwarding component 205 forwards a command received from a vSM client 116 to the security module 102 (potentially after a modification of that command by the modification component 204). In general, the blocking component 206 blocks/drops a command, such that it does not reach the security module 102.

In an example of operation of the modification component 204, some commands supported by security module 102 may require specification of a namespace identifier. In one example, this namespace identifier is an ASID corresponding to a partition, though the embodiments herein are not limited to ASIDs. When issuing such commands to the vSM 109, a vSM client 116 only has knowledge of the partitions that the nested hypervisor 115 has created within the NIH partition. As such, this vSM client 116 may use an ASID that conflicts with an ASID used by the hypervisor 107 and/or by another NIH partition. As such, in embodiments, the state management component 202 maintains state 110, such as a mapping between ASIDs used within one or more NIH partitions and ASIDs that are valid and expected by the security module 102. Using this state 110, the modification component 204 modifies a command by replacing an ASID in a command issued by the vSM client 116 with an ASID expected by the security module 102.

In a particular example, the state management component 202 may start with only tracking ASIDs created by hypervisor 107 and have an empty list of mappings in state 110. Then, on a per-NIH basis, when a new ASID (i.e., not in list of mappings) is used by a given NIH partition, the state management component 202 allocates an available ASID (as understood at hypervisor 107) and adds that ASID to the mapping list in association with that NIH partition. Then, having this per-NIH mapping list as part of state 110, and presuming a correspondence between each NIH-mapped ASID and a NIH-created VM, the mapping list allows the vSM 109 to (i) efficiently apply operations to all address spaces created from within an NIH partition, (ii) invalidate all ASIDs associated with a given NIH partition (e.g., if the NIH partition becomes compromised), (iii) ensure termination of L2 VMs generated by an NIH partition when the NIH partition terminates, and (iv) reclaim ASIDs used by an NIH partition when the NIH partition terminates.

In another example of operation of the modification component 204, the state management component 202 stores, within state 110, isolation state for the L2 child partitions 121 that is configured through the vSM client 116. Then, the modification component 204 uses this state 110 to enforce that vCPUs within the NIH partition 113 (e.g., vCPU 117a and vCPU 117b) can only reference this previously configured isolation state.

In another example of operation of the modification component 204, the modification component 204 provides transparent address translation. In this example, the modification component 204 translates memory addresses within commands sent by the nested hypervisor 115 to the vSM client 116 from guest physical addresses (e.g., exposed to the NIH partition 113 by the hypervisor 107) to physical addresses (e.g., within memory 104).

In an example of operation of the blocking component 206, there may be commands that are supported by the security module 102, but which the vSM 109 blocks when received by the vSM client 116. For example, if the security module 102 supports a command for updating the firmware of the security module 102, the blocking component 206 may block that command if it is received from the vSM client 116.

In another example of another example of operation of the blocking component 206, the blocking component 206 prevents enablement of hardware isolation for memory accessed by the root partition 112, in order to provide services to the NIH partition 113. In embodiments, this services include input/output to a virtual network or storage device. In embodiments, preventing enablement of hardware isolation for memory accessed by the root partition 112 ensures that the NIH partition 113 cannot adversely impact execution or cause faults in the root partition 112, by sending commands to the vSM 109 to enable hardware protection for resources currently accessed by the root partition 112.

In another example of another example of operation of the blocking component 206, the blocking component 206 rate-limits commands forwarded to the vSM 109 and/or puts restrictions on resource usage. In embodiments, these rate-limits and/or resource restrictions ensure that services of the security module 102 cannot be exhausted by a single NIH partition.

In embodiments, the hypervisor 107 is configured to provide one or more enlightenments for instructions executed at the CPU 103. In an example, in embodiments the hypervisor 107 provides enlightenments for the RPMUPDATE and RMPADJUST instructions, which interact with entries in a reverse map table that stores permissions for physical memory pages, and which the CPU 103 uses to enforce physical isolation between memory pages. In embodiments, these enlightenments cause the hypervisor 107 to intercept RPMUPDATE/RMPADJUST instructions executed by the nested hypervisor 115, such that those instructions do not execute directly on the CPU 103—which could generate a fault and/or compromise the reverse map table. Instead, hypervisor 107 emulates the effects of these instructions to read/modify the reverse map table in a way that achieves the desired result for the nested hypervisor 115, while maintaining integrity of the reverse map table.

In order to further describe functionality of computer architecture 100, the following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

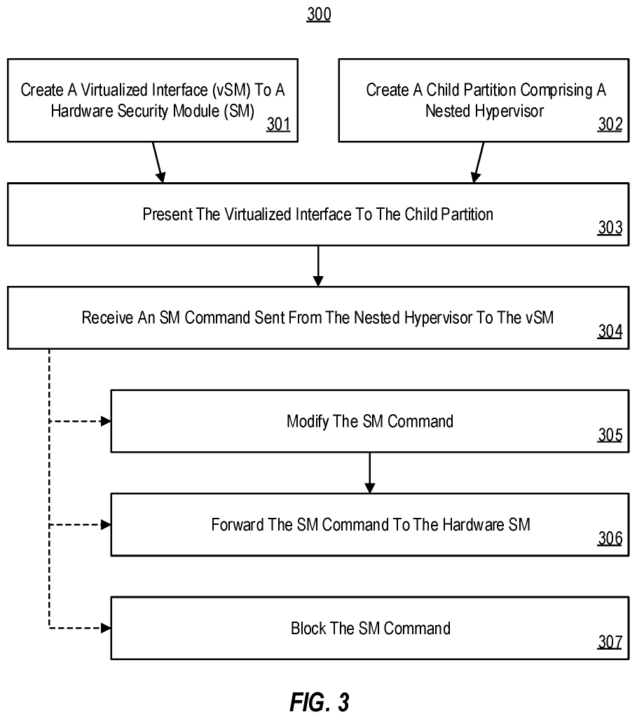

FIG. 3 illustrates a flow chart of an example method 300 for providing a nested isolation host partition (virtual machine). Method 300 will be described with respect to the components and data of computer architecture 100.

In embodiments, instructions for implementing method 300 are encoded as computer-executable instructions (e.g., hypervisor 107, including vSM 109) stored on a hardware storage device (e.g., storage 105) that are executable by a processor (e.g., CPU 103) to cause a computer system (e.g., host computer system 101) that comprises a security module (e.g., security module 102) to perform method 300. In some embodiments of method 300 the security module 102 one of an AMP PSP, an INTELTDX, or an ARM Confidential Compute Architecture module. While the security module 102 is illustrated in FIG. 1 as being external to the CPU 103, in some embodiments the CPU 103 software that executes on the CPU 103 (e.g., a TDX module), such that the security module 102 executes on the CPU 103. Thus, in some embodiments of method 300 the security module executes on the processor, while in other embodiments of method 300 the security module is external to the processor.

Method 300 comprises an act 301 of creating a virtualized interface (vSM) to a hardware security module (SM). In some embodiments, act 301 comprises creating a virtualized interface to the security module. In an example, the hypervisor 107 instantiates the vSM 109, which is a virtualized representation of security module 102. The vSM 109 includes functionality (e.g., communications component 201) for communicating with a vSM client 116 in a nested hypervisor 115 (or a plurality of vSM clients in a plurality of nested hypervisors) and with the security module 102 (e.g., via the SM client 108). The vSM 109 also includes functionality (e.g., filtering component 203) for filtering and/or modifying commands received from vSM clients. In embodiments, act 301 brings about a technical effect of providing an interface through which L1 partitions can send commands for interacting with the security module 102.

Method 300 comprises an act 302 of creating a child partition comprising a nested hypervisor. In an example, based on a command received from the root partition 112, the hypervisor 107 partitions portions of host computer system 101 resources (e.g., CPU 103, memory 104, storage 105, etc.) into a child partition, and initializes the nested hypervisor 115 within that partition. In embodiments, the nested hypervisor 115 comprises the vSM client 116. Since the nested hypervisor 115 comprises the vSM client 116, this child partition becomes a NIH partition 113, which is configured to interface with the security module 102 to create hardware-isolated L2 VMs. Thus, in embodiments, act 302 brings about a technical effect of creating a new type of child partition (i.e., the NIH partition 113) that enables the creation of hardware isolated L2 VMs, potentially along with conventional L2 VMs.

In FIG. 3, act 301 and act 302 are illustrated with no particular ordering between the acts. As such, in various embodiments act 301 and act 302 are performed serially (in either order), or in parallel.

Method 300 comprises an act 303 of presenting the virtualized interface to the child partition. In an example, the hypervisor 107 presents the vSM 109 (which was created by the hypervisor 107 in act 301) to the NIH partition 113, enabling the vSM client 116 at the NIH partition 113 to send commands to the vSM 109. In embodiments, act 303 brings about a technical effect of providing the NIH partition 113 an interface to the security module 102.

Method 300 comprises an act 304 of receiving an SM command sent from the nested hypervisor to the vSM. In some embodiments, act 304 comprises receiving a command sent by a virtual security module operating in the nested hypervisor, the command formatted for use by the security module. In an example, the communications component 201 at the vSM 109 receives a command sent by the vSM client 116. In embodiments, the command is a request to utilize hardware-based virtual machine isolation functionality of the security module 102. In embodiments, the command is a request for the security module 102 to perform at least one of (i) encrypting at least a portion of memory allocated to a virtual machine executing on the nested hypervisor (e.g., SEV), (ii) encrypting one or more registers corresponding to the virtual machine executing on the nested hypervisor (e.g., SEV-ES), or (iii) providing memory integrity protection for the virtual machine executing on the nested hypervisor (e.g., SEV-SNP).

As shown in FIG. 3, after act 304, method 300 comprises one or more of (i) an act 305 of modifying the SM command, (ii) an act 306 of forwarding the SM command to the hardware SM, or (iii) an act 307 of blocking the SM command.

In some embodiments, act 305 comprises, based on receiving a command at the virtualized interface from the nested hypervisor, the virtualized interface modifying the command. In an example, the modification component 204 modifies the command received by the communications component 201 from the vSM client 116, in order to ensure the command can be executed correctly by the security module 102. In embodiments, act 305 brings about a technical effect of ensuring that a command issued by the vSM client 116 can be properly executed by the security module 102. In one example, the modification component 204 utilizes the state 110 to modify a command by replacing a namespace identifier (e.g., a first ASID) in a command issued by the vSM client 116 with a namespace identifier (e.g., a second ASID) expected by the security module 102. Thus, in some embodiments, act 305 comprises a namespace translation.

In some embodiments, act 306 comprises, based on receiving a command at the virtualized interface from the nested hypervisor, the virtualized interface forwarding the command to the security module. In an example, the forwarding component 205 uses the communications component 201 to forward a command received by the communications component 201 from the vSM client 116 to the security module 102 (e.g., via the SM client 108). In embodiments, if the command was modified in act 305, forwarding the command to the security module in act 306 comprises forwarding a modified command to the security module. In an example, the forwarding component 205 uses the communications component 201 to forward a command modified by the modification component 204 to the security module 102 (e.g., via the SM client 108). In embodiments, act 306 brings about a technical effect of communicating a command from the NIH partition 113 to the security module 102, enabling the NIH partition 113 to utilize functionality of the security module 102.

In some embodiments, after act 306, the security module 102 sends a reply back to the vSM 109, and the vSM 109 forwards that reply to the vSM client 116 within the nested hypervisor 115. Thus, in some embodiments of method 300, the virtualized interface receives a reply from the security module and forwards the reply to the nested hypervisor.

In some embodiments, act 307 comprises, based on receiving a command at the virtualized interface from the nested hypervisor, the virtualized interface blocking the command. In an example, the blocking component 206 blocks a command by the communications component 201 from the vSM client 116, such that the command does not reach the security module 102. In embodiments, act 307 brings about a technical effect of limiting access that that NIH partition 113 is given to the security module 102, which can, for example, enhance security. For example, in embodiment, the blocking component 206 prohibits any NIH from issuing a firmware update command to the security module 102.

Accordingly, the embodiments described herein enable NIH partition/VM, which comprises an L1 nested hypervisor capable of interacting with a hardware security module to create one or more hardware isolated L2 VMs, potentially along with one or more conventional L2 VMs. Since the function of the NIH is under tenant control, the NIH enables a tenant to create VMs that utilize hardware isolation features, rather than relying on hosting providers to create those VMs. Thus, an NIH enables a tenant-rather than a hosting provider—to granularly control of resource allocations to VMs that are used to operate modular guest software. This means that host computer system resources can be more efficiently allocated to meet the needs of the guest software that utilizes a mix of convention VMs and hardware isolated VMs than was possible prior to the invention of the NIH, with an overall technical effect of this is a more efficient use of computing resources.

Additionally, since the NIH is an L1 VM, all the L2 VMs that are created within the NIH are treated together as a single unit by the L0 hypervisor. This means that the L0 hypervisor automatically manages (e.g., migrates, shuts down, starts, etc.) all the L2 VMs within the NIH as a single unit when the NIH is itself migrated, shut down, started, etc. As such the NIH enables a mix of hardware-isolated and convention VMs to be managed as a single unit, which provides a technical effect of simplifying VM-related configuration information and VM-related management tasks.

Furthermore, as discussed, the hypervisor 107 tracks information (e.g., ASIDs) received from one or more NIH VMs as state 110, and translates that information to ensure proper use of the security module 102 by the NIH VM(s), thereby providing an additional technical effect of resolving conflicts between how different NIH VMs expect to use the security module 102.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system (e.g., host computer system 101) that includes computer hardware, such as, for example, one or more processors (e.g., CPU 103) and system memory (e.g., memory 104), as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media (e.g., storage 105) are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media (e.g., network 106) can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

1. A computer system that supports a nested isolation host, comprising:
a processor;
a security module that is configured to provide hardware-enforced virtual machine isolation functionality; and
a hardware storage device that stores computer-executable instructions that are executable by the processor to cause a hypervisor at the computer system to at least:
create a virtualized interface to the security module;
create a child partition that comprises a nested hypervisor;
present, to the child partition, the virtualized interface to the security module, wherein the virtualized interface enables the nested hypervisor to request hardware isolation features for virtual machines created by the nested hypervisor; and
based on receiving a command at the virtualized interface from the nested hypervisor, perform one of:
modify the command, and forward a modified command to the security module;
forward the command to the security module; or
block the command.

2. The computer system of claim 1, wherein the virtualized interface modifies the command, and forwards the modified command to the security module.

3. The computer system of claim 2, wherein modifying the command comprises a namespace translation.

4. The computer system of claim 1, wherein the virtualized interface forwards the command to the security module.

5. The computer system of claim 1, wherein the virtualized interface:
receives a reply from the security module; and
forwards the reply to the nested hypervisor.

6. The computer system of claim 1, wherein the virtualized interface blocks the command.

7. The computer system of claim 1, wherein the security module executes on the processor.

8. The computer system of claim 1, wherein the security module is external to the processor.

9. The computer system of claim 1, wherein the command is a request to utilize hardware-based virtual machine isolation functionality of the security module, including a request for the security module to perform at least one of:
encrypting at least a portion of memory allocated to a virtual machine executing on the nested hypervisor;
encrypting one or more registers corresponding to the virtual machine executing on the nested hypervisor; or
providing memory integrity protection for the virtual machine executing on the nested hypervisor.

10. (canceled)

11. A method, implemented at a computer system that includes a processor and a security module that is configured to provide hardware-enforced virtual machine isolation functionality, for providing a nested isolation host, the method comprising:
creating, at a hypervisor, a virtualized interface to the security module;
creating, at the hypervisor, a child partition that comprises a nested hypervisor;
presenting, by the hypervisor to the child partition, the virtualized interface to the security module, wherein the virtualized interface enables the nested hypervisor to request hardware isolation features for virtual machines created by the nested hypervisor; and
based on receiving a command at the virtualized interface from the nested hypervisor, performing one of:
modifying the command, and forwarding a modified command to the security module;
forwarding the command to the security module; or
blocking the command.

12. The method of claim 11, wherein the virtualized interface modifies the command, and forwards the modified command to the security module.

13. The method of claim 11, wherein the virtualized interface forwards the command to the security module.

14. The method of claim 11, wherein the virtualized interface blocks the command.

15. The method of claim 11, wherein the command is a request to utilize hardware-based virtual machine isolation functionality of the security module, including a request for the security module to perform at least one of:
encrypting at least a portion of memory allocated to a virtual machine executing on the nested hypervisor;
encrypting one or more registers corresponding to the virtual machine executing on the nested hypervisor; or
providing memory integrity protection for the virtual machine executing on the nested hypervisor.

16. The method of claim 11, wherein the security module executes on the processor.

17. The method of claim 11, wherein the security module is external to the processor.

18. The method of claim 12, wherein modifying the command comprises a namespace translation.

19. The method of claim 11, wherein,
the hypervisor operates in L0 at the computer system; and
the child partition is an isolation host partition that operates in L1 at the computer system.

20. The computer system of claim 1, wherein,
the hypervisor operates in L0 at the computer system; and
the child partition is an isolation host partition that operates in L1 at the computer system.

21. a hardware storage device that stores computer-executable instructions that are executable by a processor to cause a hypervisor at a computer system to at least:
create a virtualized interface to a security module;
create a child partition that comprises a nested hypervisor;
present, to the child partition, the virtualized interface to the security module, wherein the virtualized interface enables the nested hypervisor to request hardware isolation features for virtual machines created by the nested hypervisor; and
based on receiving a command at the virtualized interface from the nested hypervisor, perform one of:
modify the command, and forward a modified command to the security module;
forward the command to the security module; or
block the command.
